(19) United States
(12) Patent Application Publication
(10) Pub. No.: US 2014/0196578 A1
(43) Pub. Date: Jul. 17, 2014

(54) VISUAL INDICATOR FOR TURN-OF-NUT TORQUE APPLICATION

(71) Applicant: Wright Tool Company, Barberton, OH (US)

(72) Inventors: Kenneth R. Milligan, Uniontown, OH (US); Wayne Snyder, Silverlake, OH (US)

(73) Assignee: Wright Tool Company, Barberton, OH (US)

(21) Appl. No.: 14/155,507

(22) Filed: Jan. 15, 2014

Related U.S. Application Data
(60) Provisional application No. 61/753,605, filed on Jan. 17, 2013.

(51) Int. Cl. B25B 13/06; B25B 23/00

(52) U.S. Cl. CPC B25B 13/06; B25B 23/00
USPC 81/124.6; 81/121.1

(57) ABSTRACT

A socket for a turn-of-nut torque application includes at least one visual indicator for indicating a turn-of-nut position. In a preferred embodiment, a visual indicator is precisely machined into the exterior surface of the elongated body portion of the socket. The visual indicator may correspond with an interior corner of the nut end recess. Several visual indicators may be provided, and each visual indicator may correspond with a different interior corner of the nut end recess. The visual indicator may further comprise a permanent paint, and each additional visual indicator may comprise a different colored permanent paint.

### CROSS-REFERENCE TO RELATED APPLICATIONS

This application claims priority to U.S. provisional patent application No. 61/753,605 filed on Jan. 17, 2013, which is incorporated herein by reference in its entirety.

### BACKGROUND OF THE INVENTION

1. Field of the Invention

The present invention relates in general to sockets and in particular to sockets having visual indicators thereon. More particularly, this invention relates to a socket having a visual indicator for a “Turn-of-Nut” (“TON”) torque application.

2. Description of the Prior Art

Many types of fasteners, including nuts and bolts, require a specific predetermined amount of torque or turn in order to remain fastened under various types of loading conditions. For these cases requiring a specific torque, typically, a nut is initially tightened by hand or by use of an impact gun with a socket. The final tightening of the nut to reach a specific torque value to provide proper pre-tensioning is achieved by using a torque wrench which is well known in the art. This requires a worker to carry and use a different tool (i.e. a torque wrench) on his or her tool belt, in addition to any other necessary tools. Thus the worker must constantly wield more than one tool and place and replace the respective tools in his or her tool belt. These separate tools also add extra weight to the worker's tool belt which can cause problems with the worker's balance when standing and climbing depending on the location of the fastener. For example, a worker may be fastening nuts on high tension wires which require overhead use of such tools. Such tools are often unwieldingly heavy. Moreover, torque wrenches may be difficult to use in tight spaces due to the size of typical torque wrenches and due to the location of the fastener. Many torque wrenches have a dial or other type of read-out indicator for indicating the torque imposed on a fastener. Such dials or read-out indicators must be able to be read by the worker, which may be difficult or impossible in the aforesaid tight or cramped spaces.

U.S. Pat. No. 5,123,313 to Andersson discloses a torsion socket for use with an impact gun for tightening wheel nuts for automobiles. The torsion socket includes a torsion shaft and a nut socket at one end of the torsion shaft. Rotation indicia are fashioned on an exterior portion of the nut socket to permit an operator who is tightening a wheel nut to easily visually determine when the torsion shaft relieves the impact torque from the nut socket and when the nut socket stops turning. These rotation indicia on the socket include a plurality of marks or cuts which are canted or angled. These markings create a solid blur line when the nut socket is rotating because the markings blend together to form the blurred image of a band. When the nut socket is no longer rotating (i.e. when the maximum designed torque is achieved), the individual markings will be distinguishable from one another. When individual markings are visually apparent, an operator is signaled to quickly release the rigger on the impact wrench to stop rotation of the power drive to prevent overtightening of the wheel nut beyond design specifications. The markings on the socket may also include a spiral groove which serves to visually indicate when socket end slows and stops rotating.

Andersson does not disclose a final tightening of the wheel nut to reach a specific torque value to provide proper pre-tensioning since the impact wrench is stopped immediately when the markings become visually apparent (i.e. when the rotation of the impact wrench slows down). In other words, Andersson does not teach the use of a torque wrench or any other tool, including the torsion socket itself, to tighten the wheel nut to a specific predetermined torque value. In this regard, the markings of Andersson do not function in the same manner as the markings disclosed herein for the present application (i.e. they are not color coded for the Turn-of-Nut technique as discussed later). Additionally, the patent to Andersson does not specifically describe how the “cuts” or “spiral grooves” are formed on the socket. Such markings may easily wear off during normal use of the tool including contact with other tools or by repeatedly being dropped on the ground such as a concrete floor. Such physical wear would prevent the visual inspection of such markings. Therefore, Andersson is silent on any method for forming the rotation indicia on the outer portion of the torsion socket.

U.S. Pat. No. 3,389,623 to Gill is directed to an apparatus for tightening a nut upon a bolt and giving a visual indication that tightening has achieved a predetermined tension in the bolt shank using two different forms of the Turn-of-Nut method. The invention includes an impact wrench in combination therewith a marking tool. The marking tool includes a chiseled end of a shaft having an operative pointed end. Operation of the impact wrench forces the shaft forwardly to cause its pointed end to bite into the end face of a bolt shank where the bolt shank protrudes beyond a nut into which the bolt shank is being tightened. As the impacting is repeated, the forward movement of the shaft will likewise be repeated and a succession of marks will be made on the end face of the bolt shank. Such marks result in the formation of a scratch or groove on the end of the bolt shank which is in the form of an arc about the axis of the bolt shank, and this arc can be checked for correct length to determine whether or not the correct amount of turn has been applied to the nut. Thus, the visual mark produced can be checked to see whether the correct amount of Turn-of-Nut has been obtained—in the event that an insufficient turn has been applied it is possible (and necessary) to re-engage the wrench with the nut to apply the desired extra amount of turn.

The modified impact gun disclosed by Gill is different than the invention disclosed in the present application. The invention herein includes precisely machined cross-hatching on an outer portion of the socket itself. On the other hand, the impact gun of Gill provides marking only on the bolt itself. Moreover, the markings on the bolt are quite small compared to the markings on the outside of the socket of the present invention. The markings of Gill must be visually inspected and measured for correct length to determine whether or not the correct amount of turn has been applied to the nut. Moreover, these small markings make visual inspection and measuring difficult. No such measuring or checking is required for the present invention.

Accordingly, there is a need for a socket tool having an easy-to-read visual indicator for Turn-of-Nut torque application in one easy step which eliminates the need for the torque wrench when tightening a fastener such as a nut. It is to this need that the present invention is directed.

### SUMMARY OF THE INVENTION

An object of the present invention is to provide an easy-to-read visual indicator for Turn-of-Nut torque application in one easy step which eliminates the need for a torque wrench when tightening a fastener such as a nut.

Another object of the present invention is to provide a visual indicator for Turn-of-Nut torque application which does not require measurement or checking.

A further object of the present invention is to provide a visual indicator for Turn-of-Nut torque application which remains visible and does not physically wear due to extended use.

It is still a further object of the present invention to provide a visual indicator for Turn-of-Nut torque application on the exterior surface of a socket.

It is yet still another object to provide a visual indicator for Turn-of-Nut torque application which is precisely machined on the exterior surface of a socket.

An additional object is to provide a visual indicator for Turn-of-Nut torque application which uses permanent paint on predetermined positions on the exterior surface of a socket.

It is a further object to provide a visual indicator for Turn-of-Nut torque application having a cross-hatching pattern.

A still further object is to provide a visual indicator for Turn-of-Nut torque application on the exterior surface of a socket which does not introduce any stress risers on the outside diameter of the socket.

### BRIEF DESCRIPTION OF THE DRAWINGS

FIG. 1A is a socket end view of a nut end portion of a preferred embodiment of the present invention. FIG. 1B is a socket side view of an elongated body portion showing a visual indicator according to a preferred embodiment of the present invention. FIG. 1C is a socket end view of a drive end portion of a preferred embodiment of the present invention.

FIG. 2 is a perspective, front view of a socket showing at least one visual indicator according to a preferred embodiment of the present invention.

FIG. 3 is a perspective, rear view of a socket showing a visual indicator according to a preferred embodiment of the present invention.

### DETAILED DESCRIPTION OF THE PREFERRED EMBODIMENTS

The preferred embodiments of the present invention are directed to an easy-to-read visual indicator for Turn-of-Nut torque application in one easy step which eliminates the need for a torque wrench when tightening a fastener such as a nut. The present invention can be used with any type of socket for tightening a nut, bolt or other type of fastener that requires a specific torque for pre-tensioning using the Turn-of-Nut technique known in the art as set forth below. Typically, a nut is initially tightened by hand or by use of an impact gun with a socket and the final tightening of the nut to reach a specific torque value to provide proper pre-tensioning is achieved by using a torque wrench as noted above. The present invention eliminates the need for the latter step of the torque wrench when tightening a fastener such as a nut.

The Turn-of-Nut concept for tightening fasteners is known in the art. Turn-of-Nut installation is a standard of structural bolt installation recognized by the Research Council on Structural Connections. Installations that require slip-critical or pre-tensioned joints, as well as hex head structural bolts, generally utilize the turn-of-nut installation. The method aims at resulting in better uniform bolt pretensions than other forms of torque control. According to the method, the user tightening the nut decides how much torque should be applied to the nut based on a pre-calculated chart of torque values (which have been determined by the user or another engineer based on the specific application). These pre-calculated torque values may correspond to a ⅓-turn, a ½-turn or a ⅔-turn of the nut, and the user achieves the required pre-tension torque value by turning the nut accordingly.

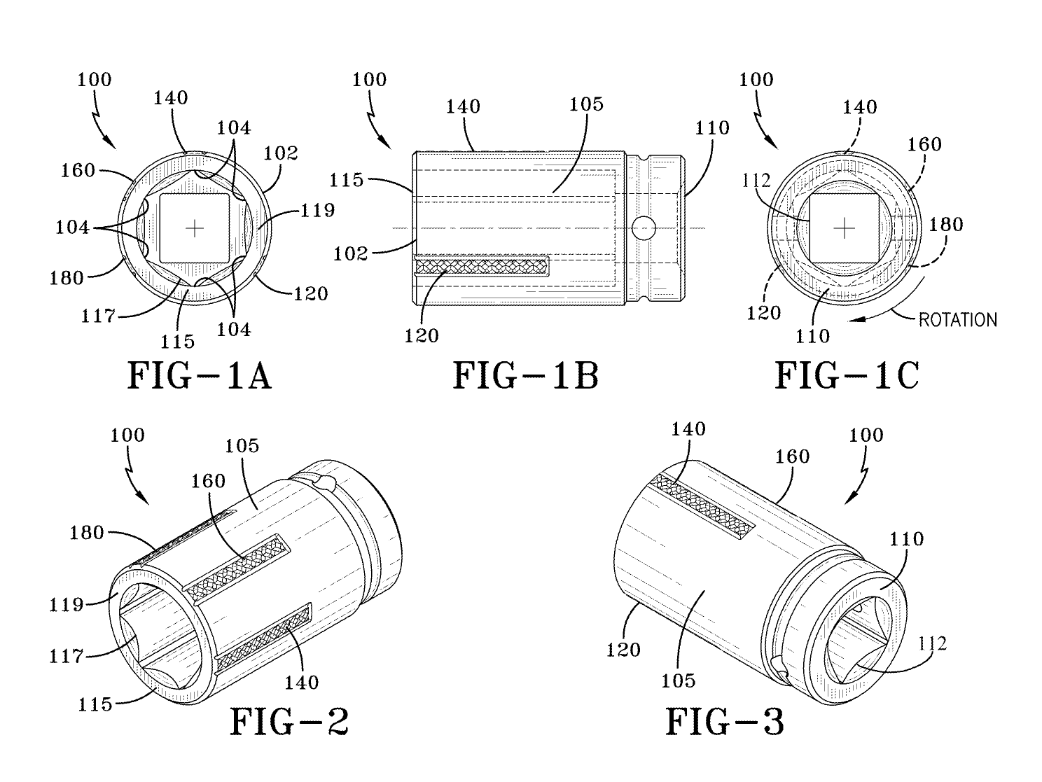

The concept is the same according to the present invention. In an embodiment of the present invention shown in FIG. 1B, an impact socket 100 comprises an elongated body portion 105 having a drive end portion 110 and a nut end portion 115. The elongated body portion 105 may be a tube-like body portion, and may have an interior surface and an exterior surface, thus forming a socket wall therebetween. The exterior surface of the elongated body portion 105 may be cylindrical, and the interior surface of the elongated body portion 105 may have a polygonal cross-section configuration. As shown in FIG. 1C, the drive end portion 110 may have an interior cavity, opening or recess 112 configured for accepting a drive part of a tool, such as the drive end of a wrench or an extension thereof. The drive end recess 112 may have an interior configuration with a polygonal cross-section. As shown in FIG. 1A, the nut end portion 115 may have an interior cavity, opening or recess 117 configured for engaging a nut and transmitting force to the nut. The nut end recess 117 may have an interior configuration with a polygonal cross-section having interior corners or points (vertices) 104. The polygonal shape of the nut end recess 117 may generally correspond with the nut to be tightened, such as a six-sided or hexagonal nut as shown in FIG. 1A. As described herein, the interior cavity, opening or recess of either the nut end portion or drive end portion may extend partially or substantially through the elongated body portion, or may extend all of the way through the elongated body portion. In certain preferred embodiments, the nut end portion 115 may further comprise a shoulder portion 119 that is proximal the exterior surface of the elongated body portion 105, or proximal an exterior edge portion 102 of the nut end portion 115.

As shown in FIGS. 1A-3, a preferred embodiment of the invention comprises a series of visual indicators at various positions on the exterior surface of the elongated body portion 105. As used herein, a visual indicator is a means for visually indicating a turn-of-nut position, or the amount of rotation a nut has undergone during a torque application. According to a preferred embodiment of the invention shown in FIGS. 1A-3, each visual indicator position corresponds with different turn-of-nut position, which may include a stop-position indicator 120, a ⅓-turn position indicator 140, a ½-turn position indicator 160, and ⅔-turn position indicator 180. Each visual indicator position on the exterior surface of the elongated body portion 105 may further correspond with a different interior corner or point 104 of the interior polygonal configuration of the nut end recess 117, as shown in FIG. 1A. In this manner, a visual indicator may be positioned on the exterior surface of the elongated body portion 105 directly opposite an interior corner 104 of the nut end recess 117, such that the interior corner 104 and visual indicator have a common socket wall portion. Each visual indicator may further have a first portion proximal the exterior edge portion 102 of the nut end portion and a second portion distal the exterior edge portion 102, as seen in FIGS. 1B and 2.

As shown in FIGS. 2-3, a preferred embodiment of the present invention has visual indicator positions with precisely machined cross-hatching patterns on the exterior surface of the elongated body portion 105. In order to provide sufficient visual indication of the turn-of-nut as the impact socket is rotating, it has been found that the length of each visual indicator may be approximately 2.000 inches plus or minus 0.020 inches on the exterior surface of elongated body portion, as measured from the edge portion 102 of the nut end portion 115, as stated above. Of course, different lengths of a visual indicator pattern could be chosen. In a preferred embodiment, the cross-hatching pattern is precisely machined using a rotary indexing head on a CNC milling machine with a radius ball end mill. The CNC milling machine is programmed with a specific code to carry out the precise machining of the socket. In certain preferred embodiments, the depth of the cross-hatching pattern may be approximately between 0.005 inches and 0.015 inches, or more preferably between 0.006 inches and 0.014 inches.

As discussed, a nut end portion is configured for engaging a nut and transmitting force to the nut. However, it should be appreciated that the present invention may be used with any variety of fastener that has a head with surfaces for loosening and/or tightening. When the socket engages the nut and force is applied, there are generally two components of force: a radial force and a circumferential force. The radial forces are those directed along a radius, or radial vector, extending outward in a straight line from the center of the fastener. The circumferential forces are those directed along a vector perpendicular to radial. It is the circumferential forces that generate torque to turn the nut or fastener and tighten it.

If the impact socket fails, it will often fail at a location corresponding with one or more of the interior corners or points of the interior polygonal configuration of the nut end recess. This is because the interior corners or points of the nut end recess are the weakest points of the overall impact socket for several reasons. First, they are typically the areas of greatest stress intensity because they are the portions of the impact socket that engage the corresponding points on the nut and experience forces as the nut is torqued. Second, the interior corners or points of the nut end recess may act as stress risers in the impact socket due to the relatively sharp inner radius of each corner. Third, the interior corners or points of the nut end recess are the portions of the nut end that have the smallest cross-sectional socket wall thickness of the overall impact socket. Therefore, in a preferred embodiment, the visual indicator cross-hatching pattern on the exterior surface of the socket must be precisely machined with great care so as not to introduce any stress risers in the socket, or as not to remove too much material thus weakening the integrity of the socket. It was for this reason that manufacturers in the prior art did not perform any type of machining on the outside circumference of prior art sockets since they did not want to risk early failure of the socket. Thus, in an embodiment of the present invention, it is preferred that the visual indicator cross-hatching pattern be machined using a CNC milling machine rather than an actual machinist that could introduce human error and not be precise. Of course, the depth of the cross-hatching pattern could be increased if the wall thickness of the socket is increased. However, although adding more material to increase the wall thickness of the socket could allow for a greater depth of the cross-hatching pattern, the increased wall thickness may make the socket heavier and more expensive to manufacture.

In a preferred embodiment of the present invention, the drive end recess 110 may be configured according to ASME B107.4 and the nut end recess 115 may be configured according to ASME B 107.17. The most recent revisions of ASME B 107.4 and ASME B107.17 as of the earliest priority date of the present application are incorporated herein by reference in their entireties. In a preferred embodiment of the present invention, the impact socket may be made of 4140 steel, and may be hardened and/or tempered to 40/44 Rc, or may be made of another material having similar hardness.

Although a preferred embodiment of the present invention may have a machined cross-hatched pattern, any other types of known techniques or patterns may be used for a visual indicator on the exterior surface of the elongated body portion of the socket. For example, etching using a vibrating tool could be done rather than machining. Different patterns may also be used to mark the various positions on the exterior surface of the socket (i.e. the stop-position indicator, the ⅓-turn position indicator, the ½-turn position indicator, and the ⅔-turn position indicator). For example, a cross-hatching pattern could designate the stop-position indicator; the ⅓-turn position indicator could be designated by a different pattern; the ½-turn position indicator could be displayed by still another pattern; and the ⅔-turn position indicator could be shown by a pattern different from the prior three patterns.

Rather than using different patterns as noted above, different lengths of the same cross-hatching pattern (or other chosen patterns) may be used to indicate the various positions on the socket. For example, the stop-position indicator could have a cross-hatching pattern length of 0.5 inches; the ⅓-turn position indicator could have a cross-hatching pattern length of 1.0 inches; the ½-turn position indicator could have a cross-hatching pattern length of 1.5 inches; and the ⅔-turn position indicator could have a cross-hatching pattern length of 2.0 inches. A user would be able to identify the various positions on the socket based on the length of the cross-hatching patterns and could fasten the nut to the proper torque based on these different lengths.

In a preferred embodiment of the present invention, a different color permanent paint is painted on each cross-hatching pattern so the paint will remain in the “valleys” of the pattern (i.e. where the depth is approximately 0.010 inches). The “valleys” allow the paint in these areas to remain visible even if the paint on the surface on the socket is rubbed off due to wear from normal use as described above. For example, the visual indicator having a cross-hatching pattern at the ⅓-turn position indicator may be painted red; the cross-hatching pattern at the ½-turn position indicator may be painted blue; the cross-hatching pattern at the ⅔-turn position indicator may be painted yellow; and the cross-hatching pattern at the stop or end-position indicator may be painted green. In this manner, precisely machined cross-hatching patterns along with the permanent paint discussed above allows for a durable and long lasting visual indicator for Turn-of-Nut torque application that should remain for the life of the socket.

An embodiment of the impact socket of the present invention and method of using the same are further described below according to the following example: cl EXAMPLE

A hexagonal nut is placed on a bolt and is pre-tightened. A green mark is drawn on one of the six points or corners of the nut, and a corresponding green mark is placed above the corner of the nut on a faceplate that is being fastened by the nut and bolt. The green marks on the corner of the nut and faceplate are co-linear. The user tightening the nut decides how much torque should be applied to the nut based on a pre- calculated chart of torque values (which have been determined by the user or another engineer based on the specific application) corresponding to a ⅓-turn, a ½-turn or a ⅔-turn of the nut. In this example, a ⅓-turn of the nut is chosen. The user aligns the impact socket of the present invention with the green line on the nut and the co-linear green line on the faceplate by placing the red visual indicator of the impact socket (corresponding to a ⅓-turn position) over the green line of the nut and co-linear to the green line on the face plate. The user engages the impact socket, turning the nut in a clockwise position to tighten it, until the stop-position indicator of the impact socket is aligned with the green line on the face plate, thus ensuring an exact ⅓ turn of the nut. It was found that this method provided an easy way to fasten the nut without the need for secondary measurement or checking, and without the need for a torque wrench.

The invention has been described in detail with particular emphasis on the preferred embodiments, but variations and modifications may occur to those skilled in the art to which the invention pertains. For example, a preferred embodiment of the present invention is directed to hexagonal impact sockets, but any number of interior corners or points of any socket may be provided depending on the shape, size, hardness of the fastener, and the application being facilitated. Accordingly, the visual indicator positions that may correspond with the corners or points of a different nut configuration may warrant different turn-of-nut positions, such as a ¼-turn position indicator, a ⅜-turn position indicator, or a ¾-turn position indicator, or any other turn position as required. Further, while an impact socket is a preferred embodiment, the tool of the present invention may be used for any Turn-of-Nut torque application. For example, it should be appreciated that the present invention could be applied not only to external wrenching systems such as sockets, but also to internal wrenching systems such as that found in hollow head cap screws such as “Allen” fasteners and internal-key wrenches.

We claim:

1. A socket comprising an elongated body portion having a first end portion and a second end portion opposite from said first end portion, said elongated body portion comprising at least one visual indicator for indicating a turn-of-nut position.

2. A socket for a turn-of-nut torque application comprising an elongated body portion having a drive end portion and a nut end portion opposite from said drive end portion, said nut end portion having an interior recess configured for engaging a nut and transmitting force to the nut, and said elongated body portion comprising an exterior surface having at least one visual indicator for indicating a turn-of-nut position.

3. The socket of claim 2 wherein said at least one visual indicator is a pattern machined into the exterior surface of the elongated body portion.

4. The socket of claim 3 wherein said at least one visual indicator machined pattern is a cross-hatching pattern machined by a CNC machine with a ball end mill, said cross-hatching pattern having a depth between 0.005 inches and 0.015 inches.

5. The socket of claim 3 wherein said at least one visual indicator machined pattern further comprises a permanent colored paint.

6. The socket of claim 2 wherein said at least one visual indicator comprises a first portion proximal an exterior edge of the nut end portion and a second portion distal said exterior edge of the nut end portion.

7. The socket of claim 6 wherein the distance between said first portion of said visual indicator and said second portion of said visual indicator defines a visual indicator length, said visual indicator length being between 0.250 inches and 2.000 inches.

8. The socket of claim 2 wherein said nut end interior recess is configured with a polygonal cross-section having at least one interior corner for engaging a nut and transmitting force to the nut, and wherein said at least one visual indicator on said elongated body exterior surface is positioned directly opposite said at least one interior corner, said at least one visual indicator and said at least one interior corner having a common socket wall portion.

9. The socket of claim 2 wherein said at least one visual indicator corresponds with a turn-of-nut stop-position.

10. The socket of claim 9 further comprising a ⅓-turn-of-nut visual indicator position.

11. The socket of claim 10 further comprising a ½-turn-of-nut visual indicator position.

12. The socket of claim 11 further comprising a ⅔-turn-of-nut visual indicator position.

13. The socket of claim 12 wherein said turn-of-nut stop-position indicator, said ⅓-turn-of-nut visual indicator, said ½-turn-of-nut visual indicator, and said ⅔-turn-of-nut visual indicator each comprises a first portion proximal an exterior edge of the nut end portion and a second portion distal said exterior edge of the nut end portion, the distance between said first portion and said second portion defining a visual indicator length, and wherein each of said stop-position indicator, said ⅓-turn-of-nut visual indicator, said ½-turn-of-nut visual indicator, and said ⅔-turn-of-nut visual indicator is configured with a different visual indicator length.

14. The socket of claim 12 wherein said turn-of-nut stop-position indicator, said ⅓-turn-of-nut visual indicator, said ½-turn-of-nut visual indicator, and said ⅔-turn-of-nut visual indicator each comprises a pattern machined into the exterior surface of the elongated body portion, and wherein each of said stop-position indicator, said ⅓-turn-of-nut visual indicator, said ½-turn-of-nut visual indicator, and said ⅔-turn-of-nut visual indicator is configured with a different pattern.

15. The socket of claim 2 wherein said nut end portion further comprises a shoulder portion proximal said elongated body portion exterior surface.

16. A socket for a turn-of-nut torque application comprising an elongated body portion having a drive end portion and a nut end portion opposite from said drive end portion:
said drive end portion having an interior recess configured for accepting a drive end of a tool;
said nut end portion having an interior recess configured with a polygonal cross-section, said polygonal cross-section having at least one interior corner for engaging a nut and transmitting force to the nut;
said elongated body portion being configured as a tube-like body portion having an interior surface and an exterior surface defining a socket wall, said exterior surface being cylindrical and comprising at least one visual indicator for indicating turn-of-nut position,
said at least one visual indicator being precisely machined into said exterior cylindrical surface of the elongated body portion,
said at least one visual indicator comprising a first portion proximal an exterior edge of the nut end portion and a second portion distal said exterior edge of the nut end portion, and wherein said at least one visual indicator on said exterior cylindrical body portion is positioned directly opposite said at least one interior corner of said nut end recess, said at least one visual indicator and said at least one interior corner having a common socket wall portion.

17. The socket of claim 16 wherein said at least one interior corner of said nut end recess is at least four interior corners, and wherein said at least one visual indicator is four visual indicators corresponding to a turn-of-nut stop-position, a ⅓-turn-of-nut position, a ½-turn-of-nut position, and a ⅔-turn-of-nut position.

18. The socket of claim 17 wherein each of said visual indicators comprises a different color permanent paint.
